(19) United States
(12) Patent Application Publication
(10) Pub. No.: US 2008/0193247 A1
(43) Pub. Date: Aug. 14, 2008

(54) MOVABLE STORAGE RACKS FOR TRANSPORTATION OF GOODS

(75) Inventors: Ronald Zupancich, Clayton, NC (US); Jeff Bloodworth, Cary, NC (US); Ivey Anderson, Fuquay Varina, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: MARTIN MARIETTA MATERIALS, INC.

(21) Appl. No.: 11/925,256

(22) Filed: Oct. 26, 2007

Related U.S. Application Data
(60) Provisional application No. 60/863,079, filed on Oct. 26, 2006.

(51) Int. Cl. B60P 1/64; A47F 5/00; B63B 25/02

(52) U.S. Cl. 410/92; 211/134; 410/52

(57) ABSTRACT

The invention provides a racking system for the storage and transportation of goods. The racking system allows for storage and transportation of an increased amount of goods over a given area of floor space on transportation vehicles, facilitates air flow around goods being shipped to improve refrigeration, increases ease of loading and off-loading goods in relation to a transportation vehicle, and decreases time spent loading and off-loading goods. The racking system can particularly be combined with a railway car for improved long-haul transportation of goods, particularly perishable goods, such as boxed butchered meat products.

### CROSS-REFERENCE TO RELATED APPLICATIONS

The present application claims the benefit of U.S. Provisional Patent Application No. 60/863,079, filed Oct. 26, 2006, which is incorporated herein by reference in its entirety.

### FIELD OF THE INVENTION

The invention relates to racking systems for transportation of goods. More particularly, the invention relates to racking systems useful for increased and improved storage of goods during transportation in railway cars or other transportation vehicles.

### BACKGROUND

The desire and need for storage and transportation of goods, particularly temperature controlled and perishable goods, has greatly evolved over time. Today's industrial society requires transportation of goods over great distances and storage of goods for many days or weeks prior to being made available to consumers. Moreover, as production facilities have become conglomerated and centralized, the volume of goods being transported and stored has also increased. While mass production of goods can function to lower the end cost of the goods to consumers, such costs can be inflated by inherent limitations of transportation and storage.

Various types of equipment have been used in the transportation of goods from producer to retailer. Non-perishable goods can be transported by a variety of vehicles, often without regard for the passage of time between production and resale to a consumer. With perishable items, however, and particularly meats, whether frozen or freshly butchered, it is necessary for the transportation vehicle to be temperature-controlled. Such temperature control generally consists of a refrigeration system and, often, some type of insulation of the transportation vehicle.

Refrigerated train or railway cars, introduced in the late 19^{th} century, revolutionized the meat industry by allowing butchered meats (rather than live animals) to be shipped across country, thus making meat affordable to average households. Railcar shipment has since become a highly desirable mode of transporting perishable goods as extremely large volumes can be transported quickly over great distances. The volume of goods that can be shipped, however, can decrease as the average weight of the goods increase. Trucks with trailers have more recently been a vehicle of choice for interstate transportation of goods. Many trucking companies specialize in transportation of butchered meats and run entire fleets of trucks with refrigerated trailers. Rail shipment, however, obviously allows for a much greater quantity of goods to be transported in a single shipment.

Many goods, including meat products, are shipped in conventional cardboard boxes. In some instances, the use of cardboard boxes can not be avoided in light of shipping and labeling requirements from the United States Department of Agriculture (USDA). This creates an inherent limitation on the ability to ship the boxed goods, particularly relatively heavy goods, such as meat products. Cardboard boxes, while being highly versatile, can only support a limited weight load. Stacking of cardboard boxes loaded with products can easily lead to crushing if stacked beyond a certain number of boxes high. Generally, boxes of meat products are not stacked more than about six boxes high to avoid exceeding the crush limit of the boxes. This severely limits the overall weight of cargo that can be loaded on a truck or, especially, a train. A typical railcar has an interior (floor to ceiling) height of about 10 to about 15 feet. Boxes of meat products stacked as high as possible without surpassing the crush limit generally fill less than half of the available cargo volume within a typical railcar. Likewise, the inability to use all available space also correlates to an inability to meet the maximum weight load capacity of a typical railcar. In other words, conventional stacking of boxed meat products can neither “cube out” nor “weight out” a typical railcar, and a great load capacity for transportation is lost when conventional stacking of boxed meat products is used.

In addition to maximizing load, it is also generally desirable to transport the goods from production to resale with minimum down time. Such down time can arise from multiple factors including time being, or waiting to be, loaded and unloaded, “off” time for truck drivers, and traffic and weather delays. With boxed meat products, time delays particularly arise in loading and off-loading of product. Generally, the conventionally stacked boxes are loaded and off-loaded by manual labor, which can be time consuming and prone to worker delays, as well as costly. Even in situations where boxes are on pallets and are loaded and off-loaded by forklift, the stacking constraints still reduce the number of boxes that may be moved at a given time.

In light of the above limitations, it would be useful to have a system whereby goods, particularly boxes of relatively heavy products, such as meat products, could be stored and transported in a more space-efficient manner. Moreover, it would be useful to have improved methods of storing and transporting boxed goods whereby the goods could be more quickly loaded and off-loaded. Still further, it would be useful to have a system whereby a maximum volume and weight of goods, approaching the “cube out” and “weight out” for a railcar, could be achieved. Even further, it would be useful to have a system whereby an increased weight and volume of products could be easily transferred between a railcar (for long-hauling products) and a truck (for more localized product delivery), thereby improving product transport efficiency and reducing overall transportation costs. Such improvements in the transportation of goods are provided by the present invention.

### SUMMARY OF THE INVENTION

The present invention provides a racking system useful for storage and transportation of goods, particularly boxed meat products. The racking system of the present invention goes beyond the realm of conventional shelving in that it is particularly designed to accommodate goods in a most efficient packing to maximize the weight of goods that can be transferred in a long-haul vehicle, such as a truck or a railway car. The racking system is particularly useful in the storage and transportation of boxed goods, such as meat products, wherein the number of boxes that can be transported using conventional stacking of the boxes is limited by the crush limit of the boxes. The racking system is also particularly useful in the storage and transportation of perishable goods, wherein localized temperature differentials occurring with conventional storage during transportation can lead to spoilage.

The racking system of the invention is particularly characterized in that it can be standardized to provide shelf compartments of a generally useful size for product storage and transportation, or it can be customized for a particular use, such as to precisely fit a specified number of boxes of known dimensions used in a specific industry (e.g., boxes used in the bulk shipment of butchered poultry products). The racking system of the invention is further characterized by its unique interaction with the transportation vehicle, such as a railway car. In particular, the racking system can be designed to have a height and width that closely correlates to the height and width of the interior portion of the railway car, truck, or other transportation vehicle with which the racking system will be used. Such detailed sizing allows for maximum packing density of goods on the racking system (and subsequently within the transportation vehicle) and can allow for clearances necessary to move the loaded rack into the transportation vehicle and be placed within the vehicle for transport.

In one aspect, the present invention is directed to a moveable rack for storage and transportation of goods. In one embodiment, the rack comprises the following: an upper frame structure; a lower frame structure; vertical support members extending between and separating the upper frame structure and the lower frame structure; horizontal support members; and shelf members. The horizontal support members are preferably attached to one or more of the vertical support members and thereby generally support the shelf members. In such an embodiment, the vertical support members and the shelf members together form a series of columns and rows of individual shelf compartments of predefined dimensions. These shelf compartments allow for storage and transportation of a greater amount of goods than possible by conventional stacking of boxes. Moreover, in the case of goods wherein temperature control is desired, such a rack facilitates air-flow around the goods, which is useful to maintain a desired temperature and avoid “heat pockets” or areas isolated from proper refrigeration.

In further embodiments, the racking system can further comprise footing members attached to the lower frame structure. Such members can be particularly adapted for facilitating placement of the rack within a transportation vehicle. Likewise, the racking system can also comprise one or more lift stabilizing members for facilitating movement of the rack. In a particular embodiment, the lift stabilizing members can comprise “fork guides” allowing for movement via a forklift.

As previously noted, the racking system of the invention is particularly useful in the storage and transport of butchered meat products. Accordingly, it is useful for the racking system to have certain physical characteristics for accommodating such goods. For example, in one embodiment, the racking system is formed of a non-corroding material. Preferably, the racking system is also formed of a material providing strength sufficient to store and transport a relatively large weight of goods. For example, in one embodiment, the racking system is capable of storing between about 3,000 lbs (1,361 kg) and about 15,000 lbs (6,804 kg) of goods.

The racking system of the invention is particularly beneficial for increasing the overall weight of boxed products, particularly relatively heavy products, such as butchered meats, that can be stored and transported over a defined area of floor space. As noted above, storage and transportation of boxed products can be limited by the ability to stack the boxes without exceeding the crush limit of the boxes. For example, with typical boxes for storage and transportation of butchered meat products weighing in the range of 70 lbs., stacking more than six boxes one on top of the other will generally exceed the crush limit of the boxes. Accordingly, the crush limit of the boxes limits the weight of goods that can be stored and transported in a given area of transportation space, or “footprint.” For example, a box having a length of 23.5 in (59.7 cm), a width of 15.5 in (39.8 cm), and height of 7 in (17.8 cm) would have a footprint (cover a floor space area) of 364.25 in² (2376.1 cm²) or 2.53 ft² (0.28 m²). A maximum stacking of such boxes (e.g., 6 boxes high) would only utilize a vertical space of approximately 63 in (160 cm), or roughly 5 ft (1.6 m). This is less than half of the available vertical space in a typical railcar. Thus, conventional stacking of boxes allows for transportation of much less product than there is space to accommodate in a typical railcar. For example, in the above example, covering the entire floor space of a typical railcar with boxes conventionally stacked boxes high would use less than half of the total volume of the railcar. The present invention solves this problem by providing a racking system that allows for storage and transportation of an increased overall weight of boxed goods over a defined area of floor space than possible by conventional stacking of such boxes. Moreover, the racking system can be specifically sized to more fully utilize the available storage volume of a transportation vehicle, such as a railcar.

In one particular embodiment, the racking system comprises the following: an upper frame structure having a defined length and width; a lower frame structure having a defined length and width substantially similar to the length and width of the upper frame structure, the product of said length and width defining an area of floor space occupied by the storage rack; vertical support members extending between and separating the upper frame structure and the lower frame structure; horizontal support members attached to the vertical support members; and shelf members supported on the horizontal support members. The vertical support members and the shelf members together form a series of columns and rows of individual shelf compartments of predefined dimensions for storage and transportation of boxed goods while preferably facilitating air-flow around the boxes. Such a racking system is capable of storing and transporting an overall greater weight of boxed goods over the defined area of floor space than could be stored and transported in the same area of floor space by conventional stacking of the boxes one on top of another. In further embodiments, the racking system can further comprise footing members attached to the lower frame structure and adapted for facilitating placement of the rack within a transportation vehicle. Moreover, the racking system can comprise lift stabilizing members for facilitating movement of the rack, such as with a forklift.

While the racking system of the invention is particularly useful for the storage and transportation of boxed goods, it is not so limited. Rather, the racking system could be used for storage and transportation of a variety of goods in a variety of packages or containers. Accordingly, the racking system is useful for increasing the overall amount of goods that can be transported via a single shipment regardless of the packaging of the goods.

In certain embodiments the rack of the invention can be used for storage and transportation of goods wherein temperature control or refrigeration is required or advantageous. For example, the inventive rack can be used for storage and transportation of perishable items, such as meat products, frozen goods, or produce. The rack system can also be used with other products, such as electronics, wherein temperature control is beneficial.

The racking system of the invention is also useful for increasing the speed and efficiency of transportation. This is particularly seen where the racking system of the invention is combined with a transportation vehicle to form a storage and transportation system. Accordingly, in another aspect, the invention provides a transportation vehicle racking system. The racking system can be combined with any transportation vehicle commonly used for shipping relatively large quantities of goods. For example, the racking system can be combined with railway cars, truck trailers (or tractor trailers), sea cargo containers, and other shipping containers.

In one particular embodiment, the present invention provides a transport vehicle racking system. The transport vehicle racking system generally comprises a transport vehicle and one or more moveable storage racks according to the invention for storing goods during transportation. The transport vehicle preferably comprises the following: a pair of opposite side walls having interior and exterior surfaces, the distance between said side walls defining a width of the transport vehicle; a pair of opposite end walls having interior and exterior surfaces; a floor extending between and joined to the side walls and the end walls and having an upward facing support surface; a roof extending between and joined to the side walls and the end walls, the distance between the floor and the roof defining a height of the transport vehicle, wherein the side walls, the end walls, the floor, and the roof define an interior portion of the transport vehicle for housing goods for transportation; and at least one opening in at least one of the side walls and the end walls to provide access to the interior portion of the transport vehicle.

In one particular embodiment, the transport vehicle further comprises a series of tracks attached to the upward facing support surface of the floor. Such tracks are useful for aligning the inventive moveable storage racks, to maintain uniformity of the racks within the transport vehicle, and to at least partially reduce undesired movement of the racks during transportation. Preferentially, the footing members of the racks are adapted for interacting with the tracks, and the tracks are positioned on the floor of the transport vehicle to receive the footing members and facilitate positioning of the racks within the transport vehicle. For example, in a railway car where the opening is in the middle of one sidewall, the tracks could begin near the opening and extend to the end wall. Thus, a rack could be moved into the railway car, the footing members aligned in the tracks, and the rack easily positioned within the railway car. In such an embodiment, the tracks not only facilitate positioning of the racks within the railway car but also prevent side-to-side movement of the racks during transportation.

As previously noted, the racking system of the invention is particularly useful in the storage and transport of temperature controlled or perishable goods, such as butchered meat products. As such, the racking system can be integrated with a temperature-controlled transportation vehicle, such as railway car or truck trailer, and the unique design of the racking system facilitates temperature control. Therefore, in one embodiment of this aspect of the invention, the transport vehicle comprises a temperature-controlled transport vehicle, particularly a railway car, that includes a temperature control system for maintaining the interior portion of the transport vehicle within a desired temperature range. In certain embodiments, the temperature control system is customizable to the type of product being shipped. In yet further embodiments, the transportation vehicle used with the racking system comprises a total environmental control system wherein, temperature, as well as humidity are controlled. The ability of the racking system to facilitate air flow around the goods stored thereon improves the refrigeration ability of the transport vehicle and decreases the formation of heat pockets around the goods.

Of course, the novel combination of the racking system with the railway car may also be extended to other transportation vehicles without departing from this aspect of the invention. In particular, the racking system could be combined with a truck trailer to provide a truck racking system. Likewise, the invention encompasses cargo container racking systems wherein a racking system of the invention is combined with a cargo container. Still further, such systems could be extended across vehicle types. For example, a railcar tracking system and a truck racking system could be combined such that the racking system is designed to fit within a railcar and within a truck trailer. According to such an example, goods could be loaded onto racks and moved into railway cars for mass transportation to distribution centers, where the racks could be off-loaded from the railway cars and immediately loaded onto truck trailers for transportation on a smaller scale to processors, wholesalers, or retailers.

According to another aspect, the present invention provides a method of transporting goods, particularly boxed goods. The invention is particularly suited for transportation of boxed meat products. The present invention provides a method of transporting boxed meat products that overcomes the limitations generally associated with shipping boxed meat products, specifically down-time associated with loading and off-loading the boxed goods and the lost quantity of product that can be transported in a single shipment arising from the stacking limitations of boxed meat products.

In one embodiment, the invention provides a method of transporting goods comprising the following steps: moving one or more racks according to the present invention with boxed goods thereon onto a transportation vehicle; and transporting the vehicle with the loaded racks to a desired location. In further embodiments, the method of the invention may further comprise off-loading from the vehicle the one or more racks with the boxed goods thereon. The method is particularly suited to the transportation of boxed meat products.

As evident from the above description, the racking system of the invention maximizes the use of the space provided in a particular transportation vehicle. Accordingly, in another aspect, the invention provides a method for increasing the weight load of boxed good transported in a vehicle. The method is particularly useful for increasing the weight load of boxed meat products transported in a vehicle. Moreover, the method is particularly useful for increasing the weight load of boxed goods transported in a railway car.

In one particular embodiment, the invention provides a method for increasing the weight load of boxed meat products transported in a railway car. Preferably, the method comprises the following: providing a railway car having an interior portion for storing goods during transportation; providing one or more moveable storage racks according to the invention, wherein the racks have an overall height and width substantially similar to the interior height and width of the railway car; loading the boxed meat products onto the racks; and moving the loaded racks into the railway car.

### BRIEF DESCRIPTION OF THE DRAWINGS

FIG. 1 is top perspective view of a rack according to one embodiment of the invention;

FIG. 2 is a bottom perspective view of the rack of FIG. 1 with the shelf members removed;

FIG. 3 is a front view of a rack according to one embodiment of the invention;

FIG. 4 is a side view of a rack according to one embodiment of the invention;

FIG. 5 is a top perspective view of a rack according to the invention with boxed goods stored therein

FIG. 6 is a front view of a rack according to the invention particularly illustrating on embodiment of the footing members;

FIG. 7 is a detailed view of one embodiment of the invention particularly illustrating the interaction between the footing members and the tracks for receiving the footing members;

FIG. 8 is a top perspective view of a transport vehicle including tracks for use with the rack according to one embodiment of the invention; and

FIG. 9 is an end view of a transport vehicle including tracks for use with the rack according to one embodiment of the invention.

### DETAILED DESCRIPTION OF THE INVENTION

The present inventions now will be described more fully hereinafter with reference to specific embodiments of the invention and particularly to the various drawings provided herewith. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The invention comprises a racking system that provides maximized utilization of available storage space during transportation of goods and that increases efficiency of loading, transporting, and unloading goods. The racking system comprises a stand-alone rack formed to provide strength and durability and to promote temperature control of goods during shipping. The inventive rack can also include components making it uniquely interactive with a transportation vehicle. The rack can be standardized within defined size parameters to accommodate a number of transportation vehicles, thus making the rack interchangeable among vehicles. Moreover, the rack can be customized to fit specific transportation vehicles of specific dimensions. Still further, the rack can be standardized to accommodate goods packaged for shipping in a variety of packages or can be customized to precisely fit goods packaged in boxes of defined sizes. The rack system can also comprise various members useful for spacing and securing the racks within a transportation vehicle. Additionally, transportations vehicles for use with the racking system can include components for increasing the ease of manipulation of the racks within the vehicle.

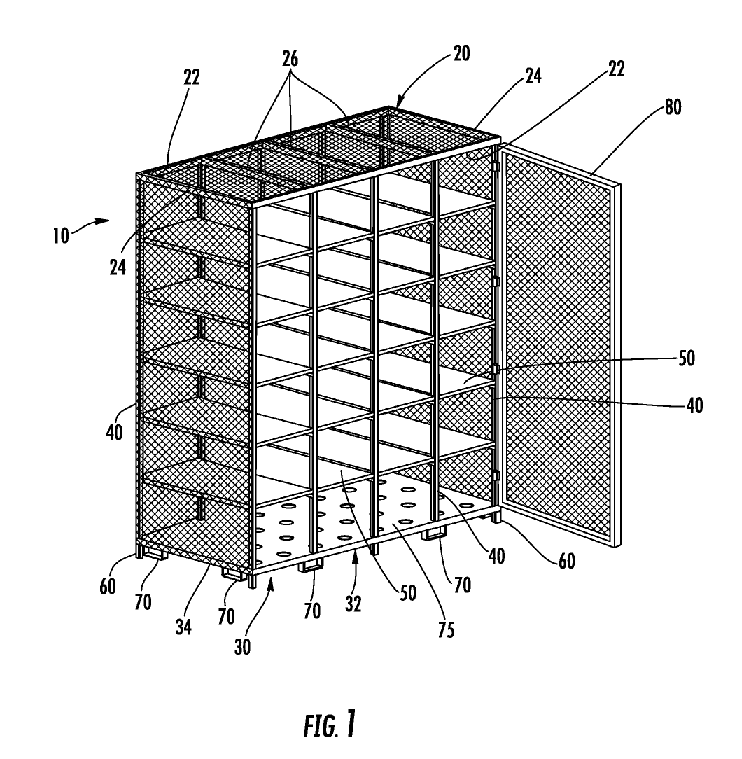

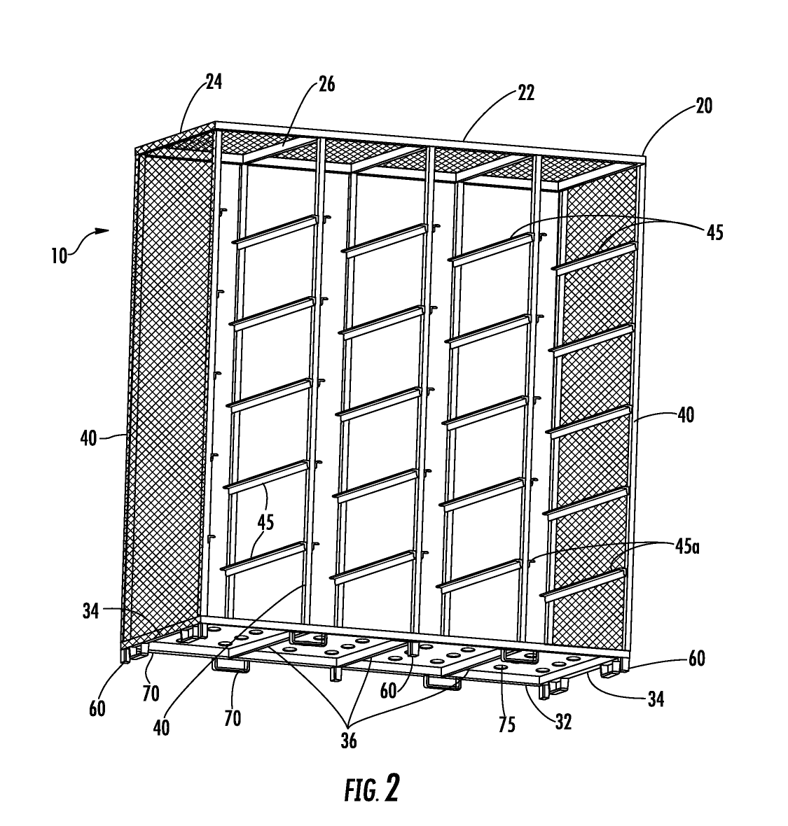

One embodiment of a rack of the invention is generally illustrated in FIG. 1 and FIG. 2. The rack 10 generally comprises an “open” construction, which is useful for facilitating air flow around goods stored thereon. Specifically, the rack does not include coverings on the front face or rear face of the rack. Furthermore, the top, bottom, and sides of the rack all generally comprise materials constructed to allow air flow. As previously noted, the inventive rack is particularly useful in the storage and transportation of goods requiring a temperature-controlled environment during transportation, such as refrigeration. Accordingly, the rack system is constructed so that air flow around the goods stored thereon is not impeded and is preferably facilitated. Such “open” construction, however, should not be construed as limiting additional embodiments. For example, the rack can include front and rear coverings that are screen-like, mesh-like, perforated, solid with cut-outs, or substantially solid. Likewise the construction of the top, bottom, and sides can take on different embodiments, including a substantially solid construction. Further constructions are also possible, including addition of doors, permanent storage spaces, and other types of coverings and modes of compartmentalization.

In the embodiment of FIG. 1 and FIG. 2, the rack 10 comprises a generally rectangular upper frame structure 20 formed of two side frame pieces 22 and two end frame pieces 24. For added strength, the upper frame 20 can include one or more upper cross-frame members 26. The rack 10 also comprises a lower frame structure 30. In one embodiment, the lower frame structure 30 is substantially similar to the upper frame structure 20. Accordingly, the lower frame structure 30 comprises two side frame pieces 32 and two end frame pieces 34. Further, for added strength, the lower frame 30 can comprise one or more lower cross-frame members 36. In respect of these basic components, the upper and lower frames are substantially interchangeable. Of course, as further described below, the upper and lower frame components can include further members differentiating the upper frame structure from the lower frame structure. Moreover, the upper and lower frames can also have different basic constructions if desired or if deemed beneficial to further the invention.

In the embodiment illustrated in FIG. 1 and FIG. 2, the rack 10 also comprises a plurality of vertical support members 40 extending between and separating the upper frame structure 20 and the lower frame structure 30. Generally, the vertical support members 40 are provided in pairs, one along the front face of the rack 10 and one along the rear face of the rack 10. It should be noted that reference to the “front” or “front face” of the rack and the “rear” or “rear face” of the rack is used only to provide points of reference for clearly describing the rack should not be construed as limiting the rack. Of course, in further embodiments, the rack could include components whereby the front face is structurally delineated from the rear face, and the skilled artisan would be capable of understanding when such delineation is proper. As shown in FIG. 1 and FIG. 2, the vertical support members 40 are placed to correspond to the placement of the end frame pieces (24 and 34) and the cross-frame pieces (26 and 36). Such placement has been found to be useful for increasing the load strength of the rack; however, more or fewer vertical support members could be used in forming the rack without departing from the present invention. Likewise altered placement of the vertical support members would also be encompassed by the present invention. Number and positioning of the vertical support members can also be altered depending upon the desired final construction of the rack, specifically in regard the number and size of shelf compartments to be included in the rack, as more fully described below.

The rack 10 further comprises a plurality of horizontal support members 45. In one embodiment, the horizontal support members 45 are attached to the vertical support members 40. In such an embodiment, it is particularly useful to provide the horizontal support members 45 in pairs for receiving shelf members, as described below. As particularly illustrated in FIG. 2, the horizontal support members 45 extend between paired vertical support members 40 from the front face of the rack 10 to the rear face of the rack 10. Again, the number of horizontal support members included in the rack can be varied depending upon the desired layout of the rack. In further embodiments, the horizontal support members, rather than extending from the front face to the rear face of the rack, could extend across the front face and across the rear face of the rack. In certain embodiments, the horizontal support members can extend from one end of the rack to the opposite end of the rack. Various further conformations of the horizontal support members are also encompassed by the invention.

The rack 10, according to the embodiment of FIG. 1, also comprises a plurality of shelf members 50. The shelf members 50 can take on a number of structures based upon the placement and construction of the vertical support members 40 and the horizontal support members 45. In FIG. 1, the shelf members 50 are readily removable from the rack 10, and an individual shelf member 50 is provided for each “pair” of horizontal support members 45 (a pair of horizontal support members 45 meaning two horizontal support members positioned at the same level, facing one another, and attached to adjacent vertical support members—an example of a “pair” of horizontal support members is illustrated as 45a in FIG. 2). In further embodiments, the shelf members 50 can be permanently attached (e.g., welded or integrally formed) to the horizontal support members or removably attached (e.g., bolted). In yet further embodiments, a single shelf member could extend beyond adjacent vertical support members. For example, a single shelf member could be used to complete an entire row of shelving in the rack. In such embodiments, fewer horizontal support members could be used. Moreover, depending upon the composition of the rack, the shelf members could be welded to the vertical support members and the horizontal support members could be discarded. Of course, the use of welding would not necessarily exclude the additional use of vertical support members. Similarly, depending upon the composition of the rack, the shelf members could be continuous with the vertical support members (i.e., be a single, uniform construction, particularly if the rack were formed of a durable polymeric material).

In further embodiments, the shelf members can comprise further components useful for facilitating storage of products and increasing stability of the stored goods during transportation. For example, the shelf members could include a lip or have a pan-like construction to prevent stored products from sliding off the shelves during transportation.

The rack 10 can further comprise a plurality of footing members 60. Such footing members 60 are preferably attached to the lower frame structure 30 and may be integrally formed therewith or attached by methods such as welding, bolting, or the like. Placement of the footing members can vary depending upon the dimensions of the racking system, as well as the particular use of the racking system. In the embodiment of FIG. 1 and FIG. 2, the footing members 60 are placed at the corners of the lower frame structure 30 and at an approximate center point along the two side frame pieces 32 of the lower frame structure 30. Placement of the footing members is preferably designed to provide stability to the racking system in an upright position and to assist in ensuring a load of goods remains balanced and stable during transportation.

The number and placement of footing members can be customized as necessary to accommodate loads of different weights. For example, in transportation of relatively light products, two or three sets of footing members may be sufficient to sufficiently balance the load and distribute the weight of the goods. In transportation of relatively heavy products however, such as meat products, the weight of a full rack borne by only two or three sets of footing members may exceed the capacity of the footing members, compromise stability and safety, or be otherwise undesirable. Accordingly, in certain embodiments, it may be useful to have an increased number of footing members to more evenly distribute the weight of the rack across the floor of the transportation vehicle.

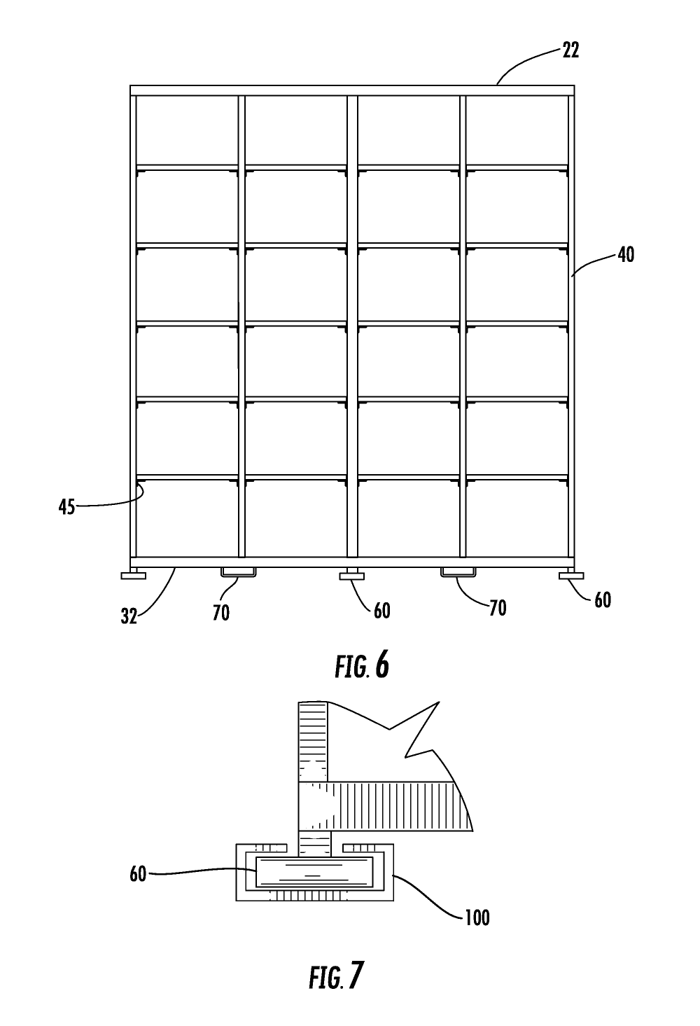

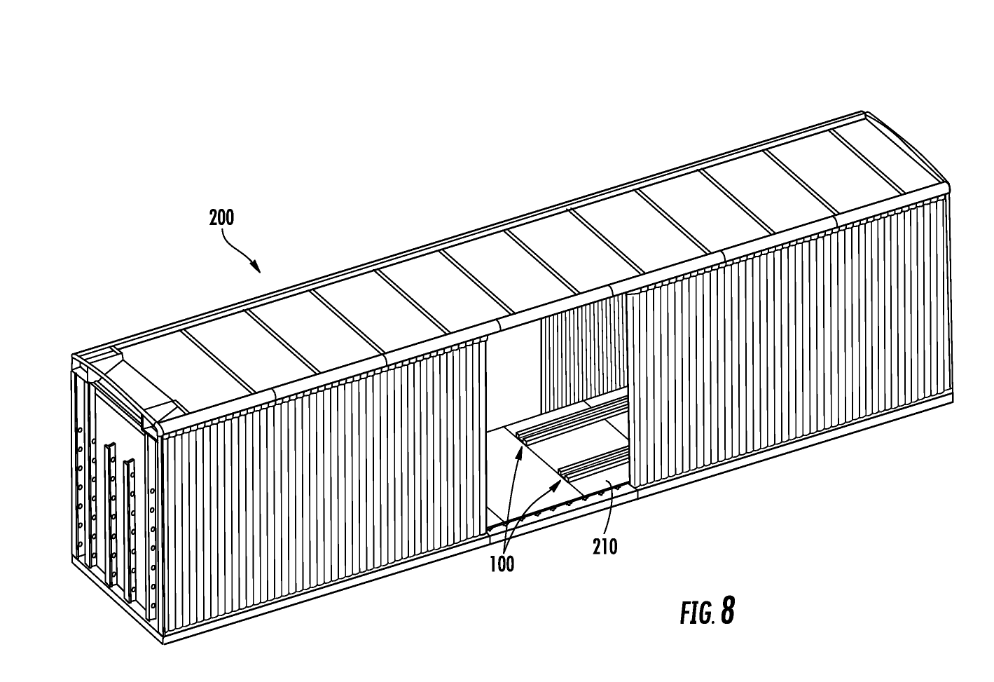

The footing members can take on a variety of forms. As seen in FIG. 2, the footing members 60 comprise pieces of square shaped tubing. In further embodiments, the footing members can comprise rollers, casters, or other wheel-type mechanisms. In yet further embodiments, as more fully described below, the footing members can take on various shapes and designs for particularly interacting with tracks that facilitate positioning and stability of the racking system during transport. Particularly, the footing members can include track engaging components having a shape that corresponds to the shape of the track and that prevents substantial vertical movement within the track but allows horizontal movement within the track. For example, the footing members could have a downward facing T-shape (as illustrated in FIG. 6) or downward facing Y-shape. Likewise, the footing members could be shaped to be spherical, oval-shaped, or have other geometric shapes useful for interacting with a track. In such embodiments, the tracks can be defined as having a horizontal axis that extends along the length of the tracks and a vertical axis that extends along the height of the tracks. The shape of the footing members (particularly the track engaging components of the footing members) and the shape of the tracks are preferably such that the footing members move within the tracks along the horizontal axis of the tracks but do not move substantially along the vertical axis of the tracks. In other words, the footing members are prevented from lifting up out of the tracks and can only exit the tracks by sliding through the tracks to an open, terminal end thereof. The interaction of the footing members with the tracks (and the corresponding shapes of the footing members and the tracks) is more clearly illustrated in FIG. 7.

The footing members can be made of the same material used in the frame structure of the racking system or can be made of a different material. In particular embodiments, the footing members are made of low friction materials to allow for ease of movement of the racking system. In further embodiments, the footing members can be made of a high friction material to resist movement of the racking system during transportation. In yet further embodiments, the footing members can be made of one material and include low friction or high friction pads or extensions attached thereto.

Preferably, the footing members are of sufficient length to raise the racking system a predetermined distance above floor level. Preferably, the predetermined distance is at least sufficient to allow use of a lift-assist device, such as a forklift; however, the predetermined distance can vary depending upon the type of footing member and the intended function of the footing member. In one embodiment, the footing members provide a free space of about 1 in (2.5 cm) to about 12 in (30 cm) between the lower frame structure and floor level. In further embodiments, the footing members provide a free space of about 2 in (5 cm) to about 10 in (25 cm), about 2 in (5 cm) to about 8 in (20 cm), about 2 in (5 cm) to about 6 in (15 cm), or about 2 in (5 cm) to about 4 in (10 cm) between the lower frame structure and floor level. In one specific embodiment, the footing members provide a free space of about 3 in (7.6 cm) between the lower frame structure and floor level.

As illustrated in FIG. 2, the inventive rack 10 can further comprise a plurality of lift stabilizing members 70 for facilitating movement of the rack 10. Such lift stabilizing members can take on a variety of shapes with varying dimensions depending upon the overall structure of the racking system. In the embodiment of FIG. 2, the lift stabilizing members 70 have a flattened U-shape and are attached to the lower frame structure 30 to form a closed rectangular space particularly adapted for receiving the forks of a forklift. Of course, other conformations could be used depending upon the desired method for movement of the racking system. Preferably, the lift stabilizing members are positioned on the racking system to maximize stability of the racking system during loading and off-loading of the rack system with goods stored thereon. As seen in FIG. 2, the lift stabilizing members 70 are present on both the side frame pieces 32 and end frame pieces 34 of the lower frame structure 30. This allows for lifting of the rack from either side or either end of the rack. Moreover, the lift stabilizing members are preferably positioned to easily accommodate a variety of lift assist devices, such as forklifts. The presence of the lift stabilizing members can also relate to the spacing provided by the footing members. For example, in one embodiment, the footing member provide a free space between the lower frame structure and floor level that is slightly greater than the vertical height of the lift stabilizing members. In certain embodiments, such vertical height is between about 2 in (5 cm) and about 6 in (15 cm), about 2 in (5 cm) to about 5 in (12.5 cm), or about 2 in (5 cm) to about 4 in (10 cm).

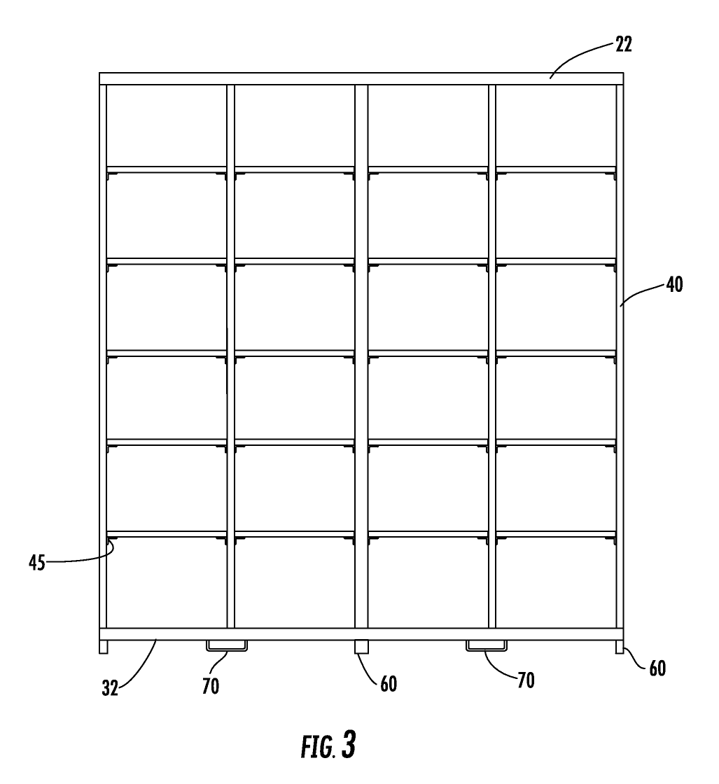

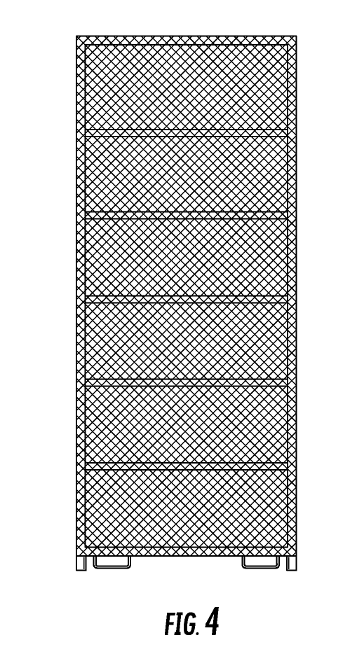

As illustrated in the embodiment of FIG. 1, when the shelf members 50 are in place, the shelf members 50 and the vertical support members 40 together form a series of columns and rows of individual shelf compartments of predefined dimensions. Such columns and row of individual shelf compartments are further illustrated in FIG. 3, which provides front view of the racking system. As particularly seen in FIG. 3, the individual shelf compartments have uniform dimensions in light of the even spacing of the vertical support members 40 and the shelf member 50 (which are resting on the horizontal support members 45). Such uniform dimension can be particularly useful for encouraging balanced loading of the racking system and to more evenly distribute the weight of the goods stored on the racking system during transportation. Of course, the spacing of the support members could be varied so that the individual shelf compartments could have varied dimensions. For example, the rack could be designed so that the shelf compartments in the bottom row are larger and the shelf compartments in the top row are smaller.

Returning to the embodiment of FIG. 1, the rows of shelf compartments, while delineated by the vertical support members 40, are substantially open from end to end of the rack. This again encourages air flow around the goods stored on the rack, which is particularly useful for transportation of refrigerated goods, such as butchered meat products. Of course, in further embodiments, the shelf compartments could be further delineated by interior “walls” between the respective columns of shelf compartments. Such walls could be attached to the vertical support members 40 and could be substantially solid or have a screen-like structure.

In certain embodiments, the racking system can further include one or more elements for at least partially covering the front face and/or rear face of the racking system. In one specific embodiment, the front and/or rear face covering element comprises a door 80. The door can be hinged to one of the vertical support members 40 and can be of dimensions to cover the full face of the racking system or only a portion of the face, such as the right or left side. The door can be comprised of any material suitable for forming other elements of the racking system. In the embodiment of FIG. 1, the door is formed of metal mesh attached to a metal frame.

The racking system can be formed from a variety of materials. Moreover, the individual components of the racking system can be formed from different materials. In the storage and transportation of goods, the racking system will generally be exposed to a variety of conditions (e.g., repeated cooling and heating) and a variety of materials, including water, cleaners, and blood from butchered meat products. Accordingly, it is preferable for the racking system to be formed of materials that are non-corrosive and that can withstand prolonged use. In the embodiment of FIG. 1-FIG. 3, the upper frame structure 20, lower frame structure 30, the cross-frame members (26 and 36), the vertical support members 40, and the footing members 60 are all formed of 2 in×2 in (5 cm×5 cm) square metal tubing. Preferably, such tubing is formed of a metal providing strength while minimizing weight. In one embodiment, the metal used is aluminum. Of course, other metals or alloys, composite materials, or polymeric materials could be used so long as the material is capable of meeting the above-noted requirements.

As seen in FIG. 1, the top and ends of the rack are enclosed with a screen-like material. In one embodiment, the screen-like material comprises expanded aluminum. Such materials provide additional strength and structure to the rack without compromising air flow. In further embodiments, the screen-like material could be replaced with different material, such as one or more bars or tubing extending from the upper frame structure 20 to the lower frame structure 30.

Supported on the lower frame structure 20 is a rack floor 75. In the embodiment of FIG. 1, the rack floor 75 comprises an aluminum plate with a series of cut-outs, again to facilitate air flow. As before, different materials could be used to form the rack floor without departing from the present invention. For example, the rack floor could comprise other metals or alloys, composite materials, or polymeric materials. Further, the rack floor can comprise a screen-like material, as used on the top and ends of the rack illustrated in FIG. 1.

The shelf members can also be formed from a variety of materials. In one embodiment, the shelf members are removable to allow for placement of boxes of relatively large dimensions. Accordingly, the shelf members are preferably formed of a lightweight, high strength material, such as a polymeric material (e.g., high density polyethylene or polypropylene). Of course, the shelf members can be formed of lightweight metals, such as aluminum or various alloys. Moreover, the shelf members can be of solid construction or can comprise screen-like materials. In still further embodiments, the shelf members can include a series of cut-outs, such as in the rack floor embodiment illustrated in FIG. 1.

The racking system of the invention is particularly beneficial in light of its ability to allow for storage and transportation of a relatively large weight of goods in comparison to the area of floor space taken up by the racking system. As would be evident to the skilled artisan, the amount of weight of goods that can be stored by the racking system for transport can vary depending upon the overall dimensions of the racking system, as well as the materials used in construction of the racking system. Preferably, the racking system of the invention is capable of storing at least about 2,000 lbs (907 kg) of goods. In further embodiments, the racking system of the invention is capable of storing at least about 3,000 lbs (1361 kg), at least about 4,000 lbs (1814 kg), at least about 5,000 lbs (2268 kg), at least about 6,000 lbs (2722 kg), at least about 7,000 lbs (3175 kg) at least about 8,000 lbs (3629 kg), at least about 9,000 (4082 kg), or at least about 10,000 lbs (4536 kg) of goods. In still further embodiments, the racking system of the invention is capable of storing between about 3,000 lbs (1361 kg) and about 15,000 lbs (6804 kg) of goods, between about 4,000 lbs (1814 kg) and about 12,500 lbs (5670 kg), or between about 5,000 lbs (2268 kg) and about 10,000 lbs (4536 kg) of goods.

The dimensions of the inventive racking system can vary depending upon the type of goods to be stored and transported, as well as the vehicle to be used for transportation. Preferably, the height and width of the racking system substantially correlate to the dimensions of the transportation vehicle so as to make use of the maximum space provided by the vehicle for transportation of goods. For example, typical transportation vehicles, such as truck trailers, railway cars, and cargo containers, are substantially box shaped and provide an interior compartment having a height and width that are substantially constant along the length of the compartment. Ideally, the racking system of the invention would have a height and width approaching the height and width of the interior compartment of the transportation vehicle. In practical use, however, allowances must be made for loading and off-loading of the racking system with the goods stored thereon. For example, when a forklift is used, a certain amount of head-space must remain between the top of the rack and the top of the interior compartment of the transportation vehicle to allow for lifting of the rack by the forklift. Likewise, it may be desirable to maintain a certain amount of space between the ends of the racking system and the sides of the interior compartment of the transportation vehicle to allow for an individual to walk therebetween for visually inspecting the goods stored on the racking system while still loaded on the transportation vehicle.

In light of the above, the height and width of the racking system can be determined as a function of the height and width of the interior compartment of the vehicle to be used for transporting the rack with goods stored thereon. In such an embodiment, the width of the rack is defined as the distance from one end of the rack to the opposite end of the rack. In certain embodiments, the rack has a height of at least about 60% of the height of the interior compartment of the vehicle to be used for transporting the rack with the goods stored thereon. In further embodiments, the height of the rack is at least about 65%, at least about 70%, at least about 75%, at least about 80%, at least about 85%, or at least about 90% of the height of the interior compartment of the vehicle to be used for transporting the racking system with the good stored thereon.

Preferably the height of the rack, according to the invention, is from about 60% to about 99% of the height of the interior compartment of the vehicle to be used for transporting the rack with the goods stored thereon. In further embodiments, the height of the rack is from about 65% to about 98%, from about 75% to about 98%, from about 75% to about 95%, from about 75% to about 92%, or from about 80% to about 90% of the height of the interior compartment of the vehicle to be used for transporting the racking system with the goods stored thereon.

In further embodiments, the width of the rack is at least about 40% of the width of the interior compartment of the vehicle to be used for transporting the rack with the goods stored thereon. Preferably, the width of the rack is at least about 45%, at least about 50%, at least about 55%, at least about 60%, at least about 65%, at least about 70%, at least about 75%, at least about 80%, at least about 85%, or at least about 90% of the width of the interior compartment of the vehicle to be used for transporting the rack with the goods stored thereon.

In specific embodiments, the width of the rack, according to the invention, is from about 40% to about 99% of the width of the interior compartment of the vehicle to be used for transporting the rack with the goods stored thereon. In further embodiments, the width of the rack is from about 50% to about 98%, from about 60% to about 98%, from about 70% to about 98%, from about 75% to about 98%, from about 75% to about 95%, from about 75% to about 92%, or from about 80% to about 90% of the width of the interior compartment of the vehicle to be used for transporting the racking system with the goods stored thereon.

In other embodiments, it may be useful for the rack to be sized such that two racks could be placed a side-by-side in a transportation vehicle, particularly a rail car. In such embodiments, it is preferable for the rack to have a width of from about 40% to about 49% of the width of the interior compartment of the transportation vehicle. In further embodiments, the rack can have a width of from about 40% to about 48%, from about 42% to about 48%, or from about 44% to about 48% of the width of the interior compartment of the vehicle to be used for transporting the racking system with the goods stored thereon.

The depth of the rack can also vary, depth being defined as the distance from the front face of the rack to the rear face of the rack. Preferably, the depth of the rack is sufficient to accommodate a large range of box sizes and to allow for sufficient storage to maximize the weight of goods that can be loaded on the rack. The depth of the rack, however, should not be such as to hinder hand loading or off-loading of the goods from the rack. In the embodiment of FIG. 1-FIG. 3, the open-face construction of the rack allows for manual loading and off-loading from both the front face and the rear face of the rack, which allows for an increased depth.

In certain embodiments, the overall height of the inventive racking system (including footing members) is between about 90 in (228.6 cm) and about 140 in (355.6 cm), about 95 in (241.3 cm) and about 130 in (330.2 cm), about 100 in (254 cm) and about 125 in (317.5 cm), or about 105 in (266.7 cm) and about 120 in (304.8 cm). In one specific embodiment, the overall height of the inventive racking system is about 115 in (292.1 cm).

In other embodiments, the overall width of the inventive racking system is between about 75 in (190.5 cm) and about 125 cm (317.5 cm), about 80 in (203.2 cm) and about 120 in (304.8 cm), about 90 in (228.6 cm) and about 115 in (292.1 cm), or about 95 in (241.3 cm) and about 110 in (279.4 cm). In one specific embodiment, the overall width of the inventive racking system is about 102 in (259.1 cm).

In yet further embodiments, the overall depth of the inventive racking system is between about 36 in (91.44 cm) and about 60 in (152.4 cm), about 38 in (96.5 cm) and about 58 in (147.3 cm), about 40 in (101.6 cm) and about 56 in (142.2 cm), about 42 in (106.7 cm) and about 54 in (137.2 cm), about 44 in (111.8 cm) and about 52 in (132.1 cm), or about 46 in (116.9 cm) and about 50 in (127 cm). In one specific embodiment, the overall depth of the inventive racking system is about 48 in (121.9 cm).

As seen in the embodiment of FIG. 1-FIG. 3, the rack system of the invention is a single unit. Other embodiments, however, are encompassed by the present invention. In one embodiment, the rack system could be modular in that it could be capable of separation into multiple units. For example, referring to FIG. 1, the rack system could be separable along the center vertical support member so that the rack having four columns of shelf compartments could become two racks, each having two columns of shelf compartments. Likewise, the rack system could be stackable so that, instead of having a single rack with six rows of shelf compartments, it could comprise two racks, each having three rows of shelf compartments. Such modularization could be useful for facilitating ease of loading and off-loading and could allow for more diverse applications of the racking system.

The rack system of the invention is particularly useful in the transportation of boxed butchered meat products. As described above, it is particularly difficult in the meat industry to transport a maximum weight load of butchered goods due to the stacking limitation of the cardboard boxes commonly used. Such problems also arise in transportation of other goods, such as fruits and vegetables, and the description herein in reference to shipment of butchered meat products is not meant to limit the scope of the invention but is used as an example of the usefulness of the invention.

Transportation of butchered meat products is somewhat standardized to the use of cardboard boxes of specific dimensions, the individual boxes being capable of holding a specified weight of products. Table 1 provides examples of several sizes of boxes (and their weight capacities) commonly used in packing and transportation of butchered meat products.

TABLE 1

| Box ID | Dimensions (inches) | Weight Capacity | |
|---|---|---|---|
| A | 23.5 × 15.5 × 9.25 | 60 | lbs |
| B | 23.5 × 15.5 × 7 | 30-40 | lbs |
| C | 23.5 × 18 × 9.25 | 65-80 | lbs |
| D | 23.5 × 16 × 6 | 81 | lbs |
| E | 21 × 14.625 × 4.563 | 20 | lbs |
| F | 17.188 × 14.5 × 9.25 | 32 | lbs |
| G | 21.25 × 17 × 7.75 | 65 | lbs |

As seen in Table 1, a relatively large weight of goods can be stored in a relatively small volume when packaged in cardboard boxes. However, the crush limit of the cardboard boxes limits the number of boxes that can be stacked one on top of another. A general rule in the shipment of boxed meat products is that 70 lb boxes are stacked no more than six boxes high. The racking system of the present invention overcomes this limitation.

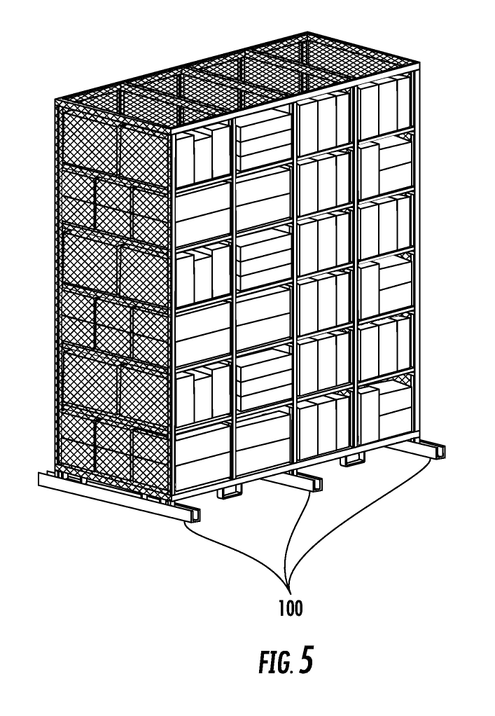

FIG. 5 illustrates a rack according to one embodiment of the invention fully loaded with a variety of boxes as described in Table 1. The rack of FIG. 5 has an overall height of 115 in (292.1 cm), a width of 102 in (259.1 cm), and a depth of 48 in (121.9 cm). Accordingly, the rack covers a floor space of 34.6 ft² (3.2 m²). As seen in FIG. 5, the individual shelf compartments each contain six boxes for a total of 144 boxes. If conventional stacking was used (i.e., limiting stacking to six boxes high), the same area of floor space covered by the rack of FIG. 5 would only be expected to hold approximately 72 boxes. Accordingly, the inventive rack system is capable of storing and transporting a greater weight of boxed goods per unit area of floor space than by using conventional stacking.

In one embodiment, the inventive racking system is characterized by the weight capacity of the rack per unit area of floor space. As noted above, the covered floor space (or footprint) of the rack is generally defined as the product of the width and depth of the rack. The footprint of the rack, therefore, can vary depending upon the dimensions of the rack. In specific embodiments, the rack has a weight capacity of at least about 75 lbs/ft² of floor space, at least about 100 lbs/ft² of floor space, at least about 125 lbs/ft² of floor space, at least about 150 lbs/ft² of floor space, at least about 200 lbs/ft² of floor space, at least about 250 lbs/ft² of floor space, or at least about 300 lbs/ft² of floor space.

Preferably, the inventive rack has a weight capacity of about 75 lbs/ft² of floor space to about 500 lbs/ft² of floor space. In further embodiments, the rack has a weight capacity of about 80 lbs/ft² to about 475 lbs/ft² of floor space, about 90 lbs/ft² of floor space to about 450 lbs/ft² of floor space, about 100 lbs/ft² of floor space to about 400 lbs/ft² of floor space, about 100 lbs/ft² of floor space to about 375 lbs/ft² of floor space, about 125 lbs/ft² of floor space to about 350 lbs/ft² of floor space, or about 150 lbs/ft² of floor space to about 300 lbs/ft² of floor space.

Stacking limitations can also determine load capacity in relation to further products for transportation. For example, electronic components or electronic consumer products can be characterized by low crush weight whereby stacking of the products can be limited. The inventive rack is particularly useful for increasing the quantity of product that can be transported at a given time.

FIG. 5 also illustrates the facilitation of air flow provided by the racking system of the invention. Even fully loaded with boxes air channels are still provided between each of the rows, and this allows for better circulation of air, which improves refrigeration.

As previously pointed out, the racking system of the invention can be standardized for use in a variety of transportation vehicles for transporting a variety of goods, or the racking system can be customized to precisely fit within a particular type of model of transportation vehicle and to specifically accommodate a particular type of goods. Accordingly, the racking system of the invention is particularly adaptable for use with specific transportation vehicles.

In one aspect, the present invention provides a railway car racking system. Such a racking system comprises a railway car and a rack according to the present invention that is particularly adapted for transportation by the railway car.

Railway cars (also known as rail cars, train cars, or boxcars) are known in the art. Railway cars can have various designs and structures but are typically rectangular in structure and formed from metallic or composite materials. Composite railway cars are particularly used as refrigerated railway cars for transportation of perishable goods, such as butchered meat products. Examples of railway cars are provided in U.S. Pat. No. 6,904,848 and U.S. Pat. No. 6,138,580, both of which are incorporated herein by reference. Examples of refrigerated vehicles are provided in U.S. Pat. No. 4,505,126 and U.S. Pat. No. 2,633,714, both of which are incorporated herein by reference.

In one embodiment, a railway car used in the railway car racking system comprises a pair of opposite side walls having interior and exterior surfaces, and a pair of opposite end walls having interior and exterior surfaces. The railway car further comprises a floor extending between and joined to the side walls and the end walls and having an upward facing support surface, and a roof extending between and joined to the side walls and the end walls. The combined side walls, end walls, floor, and roof define an interior portion of the railway car for housing goods for transportation. The width of the interior portion of the railway car is defined by the distance between the side walls, and the height of the interior portion of the railway car is defined by the distance between the floor and the roof. The railway car also comprises at least one opening in at least one of the side walls and the end walls to provide access to the interior portion of the railway car. Typically, such an opening is located at about a midpoint of one or both sidewalls of the railway car.

In a preferred embodiment, the railway car is a temperature-controlled railway car comprising at least one temperature control component. The temperature control component can comprise one or more refrigeration devices. The temperature control component can also comprise one or more insulating components. In a preferred embodiment, the temperature control component comprises at least one refrigeration device and one or more insulating components.

In further embodiments, a transportation vehicle used according to the invention, particularly a railway car or a truck trailer, comprises one or more component parts from of a composite structure. A wide variety of composite materials can be used in preparing part, or all, of the transportation vehicle. In specific embodiments, the composite material can comprise fiber reinforced polymers. Fiber reinforced polymer structures typically comprise a polymeric resin having a reinforcing fiber element embedded therein. Exemplary fiber reinforced panel structures include, but are not limited to, a solid laminate, a pultruded or vacuum-infused sandwich panel (e.g., a panel having upper and lower skins with a core therebetween), or a pultruded panel (e.g., a panel having upper and lower skins with vertical or diagonal webs therebetween). Exemplary core materials include wood, foam, and various types of honeycomb. Exemplary polymer resin materials include thermosetting resins, such as unsaturated polyesters, vinyl esters, polyurethanes, epoxies, phenolics, and mixtures thereof.

The fiber reinforcing element may comprise E-glass fibers, although other reinforcing elements such as S-glass, carbon fibers, KEVLAR®, metal (e.g., metal nano-fibers), high modulus organic fibers (e.g., aromatic polyamides, polybenzamidazoles, and aromatic polyimides), and other organic fibers (e.g., polyethylene and nylon) may be used. Blends and hybrids of such materials may also be used as a reinforcing element. Other suitable composite materials that may be used as the reinforcing element include whiskers and fibers constructed of boron, aluminum silicate, or basalt. Exemplary fiber reinforced panels and methods of making such panels are disclosed in the following U.S. patents: U.S. Pat. Nos. 5,794,402; 6,023,806; 6,044,607; 6,108,998; 6,645,333; and 6,676,785, all of which are incorporated herein in their entirety.

Specific components of the transportation vehicle (such as sidewall sections, endwall sections, the floor, and the roof) can be constructed as a sandwich panel having a core and two laminated skins secured to opposite sides of the core. An exemplary commercial embodiment of a suitable sandwich panel is the TRANSONITET® composite panels available from Martin Marietta Composites of Raleigh, N.C. In one embodiment, the core of the sandwich panel is formed of a foam material with a plurality of fibers extending through the foam and connecting the two laminated skins secured to each opposing surface of the foam core.

In specific embodiments, the transportation vehicle particularly comprises a series of tracks attached to the upward facing support surface of the floor. As noted above, such tracks are particularly useful for interacting with the footing members of the racking system to align and stabilize the racks when placed within the interior of the transportation vehicle. The tracks preferably have a shape that corresponds to the shape of the footing members of the racks. Such corresponding shape preferably indicates that the footing members have a physical structure that defines a shape with an outer surface while the track has a physical structure that defines an inner surface with substantially the same shape as the outer surface of the footing member. In other words, the footing member could form a male member and the track could form a corresponding female member for receiving the male member. Preferably, the track is structured to receive the footing member only along one axis of the track (e.g., along a horizontal, front-to-back axis) but to prevent substantial movement of the footing member within the track along the other axes (e.g., along a horizontal, side-to-side axis or along a vertical, top-to-bottom axis). By preventing “substantial movement” means the footing member fits within the track with sufficient tolerances to allow movement along the desired axis but that movement along the other axes is so limited as to disallow the footing member from completely disengaging the track through movement along the other axes. As illustrated in FIG. 7, the footing member 60 is sized to be capable of movement along the axis of the tracks 100 moving out of the plane of the page (i.e., there is a gap between the outer surface of the footing member and the inner surface of the track that is large enough to allow the movement). However, substantial movement along the horizontal axis of the track in the plane of the page is prevented since the width of the track is very close to the width of the footing member. Likewise, substantial movement along the vertical axis of the track in the plane of the page is prevented since the shape of the footing member and the shape of the track prevents the footing member from being lifted out of the track.

The tracks are preferably spaced to correspond to the spacing of the footing members on the racks. Further, the number of tracks can vary depending upon the various possible rack embodiments. For example, in a rack embodiment comprising footing members at both ends of the rack and in the middle of the rack, three tracks corresponding to the three sets of footing members can be used. Alternately, only two tracks could be used (i.e., corresponding to the footing members at the ends of the rack). Moreover, more than one set of tracks can be provided. For example, the invention encompasses embodiments wherein the rack width is less than half of the width of the transportation vehicle, such as a railcar. In such an embodiment, two rows of racks could be positioned along the length of the vehicle, and two sets of tracks corresponding to the footing members of the racks could be attached to the floor of the transportation vehicle.

The tracks can be attached to the floor of the transportation vehicle by any conventional means, such as welding or bolting. Preferably, the tracks are attached by means that will not interfere with the movement of the footing members within the tracks as the racks are positioned within the transportation vehicle. In embodiments wherein the transportation vehicle is formed of composite materials, the tracks may be integrally formed with the floor of the transportation vehicle. Accordingly, the tracks can be removably or non-removably attached to the floor of the transportation vehicle being used. Moreover, a single vehicle could include both tracks that are removably attached and tracks that are non-removably attached. In a specific embodiment, the transportation vehicle comprises a floor formed of a composite material. In such embodiments, it is particularly useful for the tracks to be integrally formed with the floor. Preferably, the integrally formed tracks can protrude upward from the upper surface of the floor (similar to separate tracks that are removably attached to a floor) or may be recessed in the floor.

Returning to FIG. 5, a rack according to one embodiment of the invention is seen with the footing members 60 positioned within tracks 100 according to one embodiment of the invention. In this embodiment, the tracks are substantially U-shaped having a width sufficient to accommodate the width of the footing members and having a depth sufficient to substantially prevent the footing members from “popping” out of the tracks during transportation.

The track can be formed from a variety of materials, and preferably comprise materials providing strength and durability. In one embodiment, the tracks comprise steel or other iron alloys. The structure of the tracks can vary depending upon the structure of the footing members. In particular embodiments, the footing members and the track are both designed to have a unique interaction. For example, the footing members can have a downward facing T-shape, and the tracks can have a shape for receiving at the end thereof a downward facing T-shaped footing member. In such an embodiment, the footing members could only be inserted at the ends of the tracks, and the racks could not be lifted out of the tracks and could only be slid out of the ends of the tracks. Other similar matching structures for the tracks and the footing members are also encompassed by the invention.

In one embodiment of a railway car including tracks, the tracks do not extend the full length of the railway car. In such an embodiment, track would begin near each end of the railway car and terminate near the door of the railway car. The tracks on each side of the railway car can be substantially mirror images, or the tracks on each side of the railway car can vary in number or positioning. Thus, a forklift carrying a rack loaded with goods can enter the railway car, turn either right or left, position the rack footing members in the tracks, and slide the racks to the end of the railway car. Of course, depending upon the structure of the tracks and the footing members, the racks could be moved to the ends of the railway car and then placed in the tracks. In this manner, it is possible to place a series of racks into the railway so that the railway car is tightly packed from each end thereof to the middle of the railway car.

One embodiment of transport vehicle, such as a railway car or a tractor trailer, is illustrated in FIG. 8. As seen therein, the vehicle 200 includes a floor 210 having tracks 100 attached thereto. In this embodiment, the tracks extend from one end (unseen) and terminate near the doorway in the center of the vehicle to allow loading of the racks. While not illustrated in FIG. 8, it is understood that a second set of tracks can be included on the opposite end of the vehicle 200.

In further embodiments, the railway car could be completely filled with racks. For example, the tracks could extend the entire length of the railway car, and the railway car could be loaded as before with the racks. Once the car is sufficiently filled so that a forklift can not navigate within the railway car, one or more additional racks could then be lifted from the end (rather than the front face or rear face) and placed into the railway car in the area of the door (the forklift placing the racks from outside of the railway car door rather than entering the railway car), the final racks being parallel to the previously loaded racks. In further embodiments, one or more additional sets of tracks could be removably or non-removably placed in the area of the railway car door, perpendicular to the direction of the previously described tracks. Such an arrangement would allow for loading of racks to each end of the railway car as previously described and, once the car is sufficiently filled so that a forklift can not navigate within the railway car, one or more additional racks could be loaded from outside of the car, face-on, so that the direction of the last loaded racks is perpendicular to the direction of the previously loaded racks. Such an embodiment would allow for the tracks to have a conformation that more securely holds the loaded racks (e.g., the T-shaped conformation described herein).

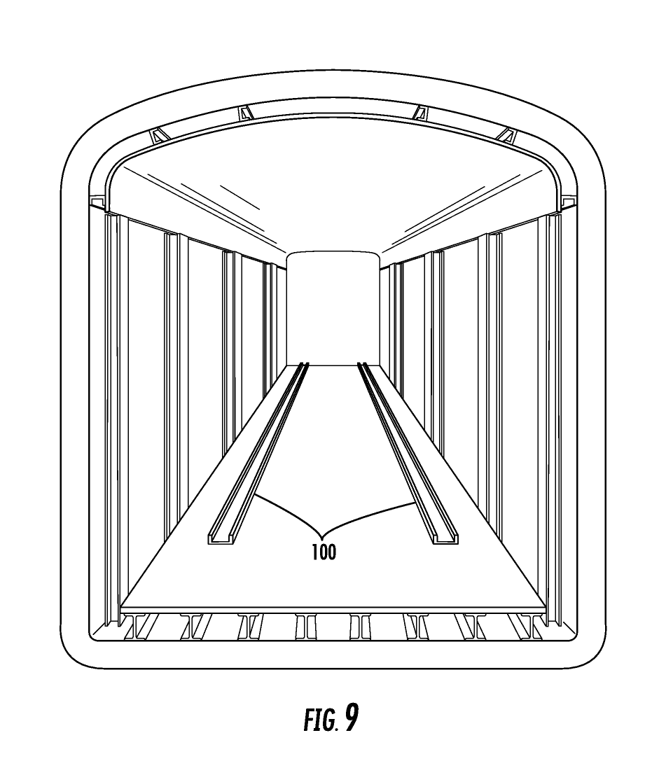

FIG. 9 illustrates a transport vehicle viewed from one end of the vehicle 200. This embodiment particularly illustrates transport vehicles, such as tractor trailers, that are more commonly loaded from an open end rather than from an opening near the center of the vehicle. In this embodiment, the tracks 100 are seen to be attached to the floor 210 and extend substantially the full length of the vehicle.

In embodiments wherein the railway car is not completely filled with the racks, an expandable device could be placed in the area of the door between the racks and expanded to contact the rack on each end of the railway car nearest the door. This would push the racks together (face to face) and prohibit movement of the racks from one end of the railcar to the other end of the railcar during transportation. In specific embodiments, the expandable device can comprise an inflatable device. In further embodiments, other devices and means can be used to limit movement of the racks during transportation. For example, the tracks can comprise locking elements that hold the racks in place to prevent movement within the railway car. In certain embodiments, the racks can further comprise spacers attached to the front and rear faces of the racks to maintain space between the racks during transport to still further facilitate air flow around the goods stored on the racks. As well as further facilitating air flow, such spacers can particularly be designed to interact with adjacent racks to lock the racks together. Such an increase in the mass would assist in preventing movement of the racks during transportation.

In further embodiments, the racks according to the invention can comprise further components useful for increasing safety and stability or for imparting further protection to the goods being transported. In particular embodiments, such further components can particularly interact with the transportation vehicle. For example, the racks can include a retention system such that the racks can be secured to the interior of the transportation vehicle. Such a retention system can simply include tie-downs or brackets on the racks corresponding to similar components on the transportation vehicle. In further embodiments, more detailed systems can by used for securing the racks to the interior of the transportation vehicle.

In yet further embodiments, the racks of the invention can include a dampening system to reduce vibration of the rack and the goods stored thereon. Such embodiments are particularly useful when the goods for transportation are shock sensitive, such as electronics. Such dampening systems could include shock members (such as conventional coiled springs or gas cylinders) in conjunction with the footing members. In further embodiments, the dampening system could be incorporated into the retention system.

As described above, the present invention further provides methods of transporting goods. In one embodiment, the method comprises loading one or more moveable storage racks according to the invention having goods stored thereon onto a transportation vehicle, and transporting the vehicle to a desired location. Of course, it is understood that the method also encompasses placing the rack onto the transportation vehicle and then loading the goods onto the rack. In further embodiments, the method also encompasses off-loading the racks from the vehicle. Moreover, the step of off-loading the racks can comprise the use of a lift-assist machine, such as a forklift.

The invention is particularly useful in that the racks, with goods loaded thereon, can be quickly loaded and off-loaded, which facilitates rapid transition between modes of transport. In one embodiment, the invention can also comprise a truck trailer racking system. Such a system is substantially similar to the railcar racking system described herein. In such an embodiment, the system comprises a rack according to the invention and a truck trailer. As recognized in the art, truck trailers generally comprise a roof, a floor, two sidewalls, and a front end wall. Such truck trailers further comprise one or more doors at the rear end thereof. In one embodiment, a truck trailer for use with the invention comprises one or more tracks attached to the floor of the trailer. As described above, the tracks can be positioned and shaped for interacting with the footing members of the inventive racks.

In particular embodiments, the invention provides a method for efficiently transferring loads between railcars and truck trailers. In a specific embodiment, racks of the invention loaded with goods can be off-loaded from a railcar having a series of tracks for interacting with the footing members of the racks. One or more of the racks can then be directly loaded onto the truck trailer by aligning the footing members with the tracks and positioning the rack within the truck trailer. Such a method removes the need for costly and time consuming labor for off-loading boxes from a railcar and loading the boxes onto the truck trailer. Rather, a single individual with a forklift can readily move one or more racks from the railcar and directly onto the truck trailer. Such ability is directly analogous to the ability at seaports to use a crane to remove cargo containers from a ship and directly place them onto a flatbed truck trailer or railcar for further transport.

The ability to customize the inventive racks for use with railcars is particularly desirable in light of the advantageous scaled economy afforded by a railcar. A single rail car can be capable of transporting the same capacity of two, three, or even four truck trailers and can be managed for a cost below that of a single truck.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A moveable storage rack for transporting goods, said rack comprising:
a. an upper frame structure;
b. a lower frame structure;
c. a plurality of vertical support members extending between and separating the upper frame structure and the lower frame structure;
d. a plurality of horizontal support members attached to the vertical support members;
e. a plurality of shelf members supported on the horizontal support members;
f. a plurality of footing members attached to the lower frame structure and adapted for facilitating placement of the rack within a transportation vehicle; and
g. a plurality of lift stabilizing members for facilitating movement of the rack;
wherein the vertical support members and the shelf members together form a series of columns and rows of individual shelf compartments of predefined dimensions for storage and transportation of goods while facilitating air-flow around the goods to maintain a desired temperature of the goods.

2. The moveable storage rack of claim 1, wherein the footing members comprise a track engaging component having a shape that corresponds to the shape of a track and that prevents substantial vertical movement within the track but allows horizontal movement within the track.

3. The moveable storage rack of claim 2, wherein the footing members have a shape corresponding to an upside-down T.

4. The moveable storage racks of claim 2, wherein the footing members have a shape corresponding to an upside-down Y.

5. The moveable storage rack of claim 1, wherein the rack has an overall height of about 90 inches to about 140 inches, an overall width of about 75 inches to about 125 inches, and an overall depth of about 36 inches to about 60 inches.

6. The moveable storage rack of claim 1, wherein the rack has a weight capacity per unit area of floor space of about 75 lbs/ft² to about 500 lbs/ft².

7. The moveable storage rack of claim 1, wherein the rack is formed of a non-corroding material.

8. The moveable storage rack of claim 1, wherein the rack stores between about 3,000 lbs and about 15,000 lbs of the goods.

9. A transport vehicle racking system comprising:
a. a transport vehicle comprising
i. a pair of opposite side walls having interior and exterior surfaces, the distance between the side walls defining a width of the transport vehicle;
ii. a pair of opposite end walls having interior and exterior surfaces;
iii. a floor extending between and joined to the side walls and the end walls and having an interior upward facing support surface and an exterior surface;
iv. a roof extending between and joined to the side walls and the end walls and having an interior and exterior surface, the distance between the floor and the roof defining a height of the transport vehicle;
the side walls, the end walls, the floor, and the roof defining an interior portion of the transport vehicle for housing goods for transportation; and
v. at least one opening in at least one of the side walls and the end walls to provide access to the interior portion of the transport vehicle; and
b. one or more moveable storage racks for storing the goods during transportation, the racks comprising:
i. an upper frame structure;
ii. a lower frame structure;
iii. a plurality of vertical support members extending between and separating the upper frame structure and the lower frame structure;
iv. a plurality of horizontal support members attached to the vertical support members;
v. a plurality of shelf members supported on the horizontal support members;
vi. a plurality of footing members attached to the lower frame structure; and
vii. a plurality of lift stabilizing members for facilitating movement of the one or more racks;
wherein the vertical support members and the shelf members together form a series of columns and rows of individual shelf compartments of predefined dimensions for storage and transportation of goods while facilitating air-flow around the goods to maintain a desired temperature of the goods.

10. The transport vehicle racking system of claim 9, wherein the transport vehicle further comprises a series of tracks attached to the upward facing support surface of the floor.

11. The transport vehicle racking system of claim 10, where the footing members and the tracks have corresponding shapes.

12. The transport vehicle racking system of claim 9, wherein the racks have an overall height that is about 75% to about 98% of the height of the transport vehicle.

13. The transport vehicle racking system of claim 9, wherein the racks have an overall width that is about 75% to about 98% of the width of the transport vehicle.

14. The transport vehicle racking system of claim 9 wherein the transport vehicle comprises a temperature-controlled transport vehicle, and wherein the transport vehicle further comprises a temperature control system for maintaining the interior portion of the transport vehicle within a desired temperature range.

15. The transport vehicle racking system of claim 9, wherein the transport vehicle comprises at least one composite panel.

16. The transport vehicle racking system of claim 9, wherein at least the floor of the transport vehicle is formed of a composite material.

17. The transport vehicle racking system of claim 16, wherein the transport vehicle comprises a series of tracks integrally formed with the floor.

18. A method of transporting boxed products comprising:
a. loading onto a transportation vehicle one or more moveable storage racks having one of more boxes of products thereon for storage during transportation, wherein the racks comprise:
i. an upper frame structure;
ii. a lower frame structure;
iii. a plurality of vertical support members extending between and separating the upper frame structure and the lower frame structure;
iv. a plurality of horizontal support members attached to the vertical support members;
v. a plurality of shelf members supported on the horizontal support members;
vi. a plurality of footing members attached to the lower frame structure; and
vii. a plurality of lift stabilizing members for facilitating movement of the one or more racks;
wherein the vertical support members and the shelf members together form a series of columns and rows of individual shelf compartments of predefined dimensions for storage and transportation of the boxed products while facilitating air-flow around the boxed products to maintain a desired temperature; and
b. transporting the vehicle to a desired location.

19. The method of claim 18, further comprising off-loading from the vehicle the one or more racks with the boxed products thereon.

20. The method of claim 19, wherein said off-loading step comprises the use of a lift-assist machine.

21. The method of claim 20, wherein the lift-assist machine comprises a fork lift.

22. The method of claim 18, wherein the vehicle comprises one or more tracks for receiving the footing members on the one or more moveable storage racks.

23. The method of claim 18, wherein the footing members and the tracks have corresponding shapes.

24. The method of claim 18, wherein the vehicle comprises a railway car,

25. The method of claim 18, wherein the vehicle comprises a tractor trailer.

26. A method for increasing the load of boxed products transported in a railway car, the method comprising:
a. providing a railway car comprising:
i. a pair of opposite side walls having interior and exterior surfaces, the distance between the side walls defining a width of the railway car;
ii. a pair of opposite end walls having interior and exterior surfaces, the distance between the end walls defining a length of the railway car;
iii. a floor extending between and joined to the side walls and the end walls and having an interior upward facing support surface and an exterior surface;
iv. a roof extending between and joined to the side walls and the end walls and having an interior and exterior surface, the distance between the floor and the roof defining a height of the railway car;
the side walls, the end walls, the floor, and the roof defining the interior portion of the railway car; and
v. at least one opening in at least one of the side walls and the end walls to provide access to the interior portion of the railway car;
b. providing one or more moveable storage racks for storing the boxed products during the transportation, the racks comprising:
i. an upper frame structure;
ii. a lower frame structure;
iii. a plurality of vertical support members extending between and separating the upper frame structure and the lower frame structure;
iv. a plurality of horizontal support members attached to the vertical support members;
v. a plurality of shelf members supported on the horizontal support members;
vi. a plurality of footing members attached to the lower frame structure; and
vii. a plurality of lift stabilizing members for facilitating movement of the one or more racks;
wherein the vertical support members and the shelf members together form a series of columns and rows of individual shelf compartments of predefined dimensions for storage and transportation of the boxed meat products while facilitating air-flow around the boxed products to maintain a desired temperature; and
wherein the one or more racks have an overall height that is about 75% to about 98% of the height of the railway car and an overall width that is about 75% to about 98% of the width of the railway car; and
c. moving the racks loaded with the boxed products into the railway car.

27. The method of claim 26, wherein the railway car further comprises a series of tracks attached to the upward facing support surface of the floor.

28. The method of claim 26, wherein the footing members and the tracks have corresponding shapes such that the footing members move within the tracks along a horizontal axis of the tracks but do not move substantially within the tracks along a vertical axis of the tracks, and wherein said step of moving the racks into the railway car comprises sliding the footing members into the tracks.

29. The method of claim 26, wherein the railway car comprises at least one composite panel.

30. The method of claim 26, wherein at least the floor of the railway car is formed of a composite material.

31. The method of claim 29, wherein the railway car comprises a series of tracks integrally formed with the floor.

32. The method of claim 26, wherein each of the one or more racks has a weight capacity per unit area of floor space of about 75 lbs/ft² to about 500 lbs/ft².
